(19) United States
(12) Patent Application Publication
(10) Pub. No.: US 2006/0168972 A1
(43) Pub. Date: Aug. 3, 2006

(54) Air-conditioning thermostat

(76) Inventor: Warren C. Fry, Pittsburgh, PA (US)

Correspondence Address: Warren C. Fry, 108 Lebanon Church Road, Pittsburgh, PA, 15236, US

(21) Appl. No.: 11/049,391

(22) Filed: Feb. 3, 2005

(51) Int. Cl. F24F 7/00; G05D 23/32; F28D 1/00; F28F 13/00

(52) U.S. Cl. 62/157; 165/267

(57) ABSTRACT

A thermostat based on indoor effective-temperature with cooling time a function of the difference between the inside temperature and temperature-set while off time is the remainder of a time cycle. This permits indoor temperature to vary with heat-load to provide comfort and conserve power under all heat-load conditions. During high heat-load conditions it can provide comfort and save a significant amount of power. It provides comfort down to temperature-set, when the heat load decreases in the evenings and at night. For low heat-load conditions, it eliminates cooling under-shoot and controlled off time reduces or eliminates stuffiness between cooling cycles.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to air conditioning thermostats that use a relative humidity sensor to modify the sensed temperature and permit the inside temperature to change as a function of the heat-load imposed on the air conditioning system.

2. Background of the Invention

The control method used in most conventional air-conditioning thermostats operates on an absolute temperature control principal. The desired indoor temperature is set by the temperature control irrespective of variation in outdoor temperature. Excessive cooling or inadequate cooling of a house or room adversely effects the physical condition of some or all of occupants in a house or room. Electrical power is wasted when an air conditioner provides cooling in excess of the amount required for an acceptable indoor temperature.

It is well known in the industry that there is a relationship between the outside temperature and indoor temperature as it effects comfort. When the temperature outside of the space to be air-conditioned is 35-degrees C., 23-degrees C., or 20-degrees C., an indoor temperature of 27-degrees C., 23-degrees C., or 20-degrees C., respectively has been generally found to be comfortable. At the lower of the two outside temperatures the inside temperature, which will provide comfort is the same as the outside temperature but as the outside temperature rises to 35 degrees C. then an inside temperature of 27 degree C. is generally considered comfortable.

The term heat-load is the energy that must be removed from an air-conditioned space to maintain the inside temperature constant.

U.S. Pat. No. 4,289,272 to Maurase (1981) discloses a temperature control apparatus that operates by calculating indoor control-temperature using a linear function of the outdoor temperature. U.S. Pat. No. 4,089,462 discloses a control system for shifting the indoor temperature-set with respect to outdoor temperature. U.S. Pat. No. 5,293,755 to Thomas (1994) interrupts operation of an air conditioner when the difference between indoor and outdoor temperature exceeds preset limit. U.S. Pat. No. 6,622,926 to Sartain (2003) discloses the use of the air conditioner's operating and non-operating time, indicative of the outdoor temperature and the heat-load on the system. When the calculated heat-load exceeds a preprogrammed limit the set-point temperature is raised to reduce the duty cycle.

Other control systems use duty cycle to calculate heat-load. U.S. Pat. No. 4,753,388 to Rummage (1988) discloses a thermostat that senses duty cycle and to satisfy preprogrammed duty cycle limits, modifies temperature-set to increase the inside temperature.

These thermostats are on/off with a dead band between on and off. All have cooling undershoot during low heat-load conditions. Undershoot contributes to long periods of time where the thermostat doesn't call for cooling and this usually results in the space becoming stuffy between cooling cycles.

U.S. Pat. No. 4,850,198 to Helt (1989) discloses a method for energizing the compressor for a fixed time period of cooling when temperature is below temperature-set and the compressor has been off for an extended period of time. This extended off period permits a space to become stuffy before this fixed period of cooling is requested.

The above referenced patents do not take advantage of a structure's mass by providing gradual cooling of this mass as outside temperature decreases. Under low-demand conditions all the above referenced patents have excessive off time between cooling cycles. Excessive off time usually causes a space to become stuffy. And when the temperature drops below temperature-set a space almost always becomes stuffy.

U.S. Pat. No. 4,703,886 to Kirby (1987) discloses a thermostat where relative humidity is sensed and added to dry bulb temperature for further processing. A fixed frequency is used as the input to a humidity sensing circuit, which contains a device that linearly changes capacitance as the relative humidity changes. The fixed frequency input increases cost.

### BACKGROUND OF INVENTION—OBJECTS AND ADVANTAGES

It would be desirable for a thermostat based on a simple, accurate method for determining heat-load, one not requiring the use of an outside temperature sensor or the calculation of on/off ratio. A thermostat that saves power by letting the inside temperature increase above temperature-set as the heat-load increases. A thermostat that provides user adjustment of the increase in temperature for all heat-load conditions. A thermostat that provides time controlled periodic cooling for temperature conditions above temperature-set. And for low heat-load conditions a thermostat that eliminates temperature undershoot. A thermostat that will gradually remove latent heat from a structure at night, when an air conditioner is more efficient, reduce humidity and provide comfort. A thermostat that takes advantage of the structures mass to retard the rate of inside temperature increase the following day. This retarding of the temperature increase can recover a portion of the energy previously used to remove latent heat in the structure. A thermostat that provides periodic cooling with controlled off time to provide comfort when temperature increases due to increased heat-load.

Temperature modified by relative humidity improves comfort. It has been recognized that ambient temperature per se is not the sole criterion in the attainment of comfort. An American Society of Heating and Air Conditioning Engineers (ASHAE) comfort chart FIG. 1 indicates a temperature and humidity zone in which people feel comfortable. This chart contains an arbitrary index known as effective temperature, the degree to which the human body feels the warmth or cold in response to the air temperature, moisture content and air motion. There is a range of effective temperature, above and below the optimum, where a majority of persons feel comfortable. Most people feel comfortable, from below to above optimum for a range of temperature similar to the range in temperature previously incorporated in thermostats using a function of outside temperature to change the inside temperature.

Regardless of source inside temperature integrates most sources of heat. A control, based on the inside effective temperature, with cooling time a function of delta temperature above temperature-set provides a method for controlling the on time within a time cycle. My thermostat based, on this premise, doesn't control the temperature to a specific value but lets it vary with heat-load. Using this principal my thermostat provides comfort for a majority of people by taking advantage of the range of comfort temperature shown in FIG. 1.

It can provide comfort and cost savings for all heat-load conditions. And using timed cooling within a time cycle overcomes a well-known stability problem associated with using effective temperature for control.

Under low heat-load traditional thermostats have temperature undershoot which results in excessive off time. Off time is dependent on the amount of temperature undershoot and the sensing dead band. A long off time contributes to people feeling stuffy between cooling cycles. Under low heat-load conditions my thermostat provides short on time with controlled off time. The short on time permits the temperature-set to be lower because the short on time, under low heat load conditions, eliminates undershoot which can cause people to feel cold. And by controlling the off time reduces or eliminates people feeling stuffy. Permitting the temperature to change with the heat load conserves power under most heat load conditions and a significant amount of power under high heat-load conditions.

The mass of a structure has a flywheel effect that retards the rate at which inside temperature changes. Air conditioners are more efficient when the differential in temperature between the inside temperature and the outside temperature is low. Slowly cooling a structure in the evenings and throughout the night increases comfort and provides this increase in comfort at a very low cost. This is because some of the structure's latent heat was removed in the evening and night before and the structure's mass retards temperature increase the following day, recovering part of the energy previously used to remove latent heat in the structure. This recovery of energy decreases the cost of providing comfort the previous evening and night. As the heat-load increases, the inside temperature increases. The delta temperature above temperature-set determines the on time of cooling. As the heat load increases the inside temperature will gradually increase until the cooling provided balances the heat-load. Periodic cooling as the temperature increases provides comfort, while a controlled temperature increase minimizes operating costs.

My thermostat provides a means for the user to select temperature-set and the cooling provided as a function of temperature above temperature-set. For low heat-load conditions, undershoot is eliminated and stuffiness reduced or eliminated. For high heat-load it provides comfort and saves significant amounts of power. Under most heat-load conditions it can provide comfort and save power without a user having to change control settings.

Some advantages of this control method:
(a) to provide a user adjustable minimum temperature-set;
(b) to provide a user adjustable cooling response to temperature above temperature-set;
(c) to provide timed cooling for all ambient conditions above temperature-set;
(d) to provide a gradual reduction in inside temperature with decreasing heat load;
(e) to provide a gradual increase in inside temperature with increasing heat load;
(f) to provide a control that eliminates temperature undershoot at low heat-load;
(g) to provide a control that provides comfort while reducing operating costs;
(h) to provide more comfort on cool days, cool evenings and at night;
(i) to provide a stable control using effective temperature;
(j) to provide a control that automatically changes to the comfort temperature;
(k) to provide a control that takes advantage of the thermal mass of a structure;
(l) to provide control profiles for most air conditioning requirements;
(m) to reduce or eliminate stuffiness between cooling cycles.

### SUMMARY

In accordance with the present invention there are advantages to using effective temperature to compensate for the humidity effect on comfort and to using the difference between inside temperature and temperature-set to determine compressor on time within a time cycle. It can provide low demand comfort. Feeling cold, due to under shoot is eliminated and controlled off time minimizes or eliminates feeling stuffy between cooling cycles. As outside temperature drops in the evenings and at night it can slowly cool a structure to provide comfort all evening and through out the night. As the outside temperature decreases an air conditioner becomes more efficient and will remove a portion of the latent heat stored in a structure. This flywheel effect retards inside temperature increase the following day. My thermostat permits the inside temperature increase to save power while timed cooling maintains comfort. The user selects temperature-set and the amount of cooling provided as a function of the temperature above temperature-set. After making these selections comfort is maintained with variations in humidity and heat-load. And power is saved under all heat-load conditions.

### DRAWINGS—FIGURES

In the drawings, closely related figures have the same number but different suffixes.

FIG. 1 American Society of Heating and Air Conditioning Engineers (ASHAE) comfort chart.

FIG. 2 shows a block diagram of my thermostat.

FIGS. 3A to 3D shows a schematic of typical unit using discreet components.

FIG. 4 a diagram showing on time as a function of temperature above set, with a fixed delta temperature above set, scale factor 1.

FIG. 5 a diagram showing on time as a function of temperature above set, scale factor 1 & 2.

FIG. 6 a diagram showing both linear and non linear V2 as a function of V1.

FIG. 7 a diagram showing on time, as a function of temperature above set, scale factor 1 & 5.

FIG. 8 shows a microprocessor configuration of my thermostat.

FIG. 9 shows a second microprocessor configuration of my thermostat.

FIG. 10 shows an output configuration for control of room air conditioners.

### DETAILED DESCRIPTION

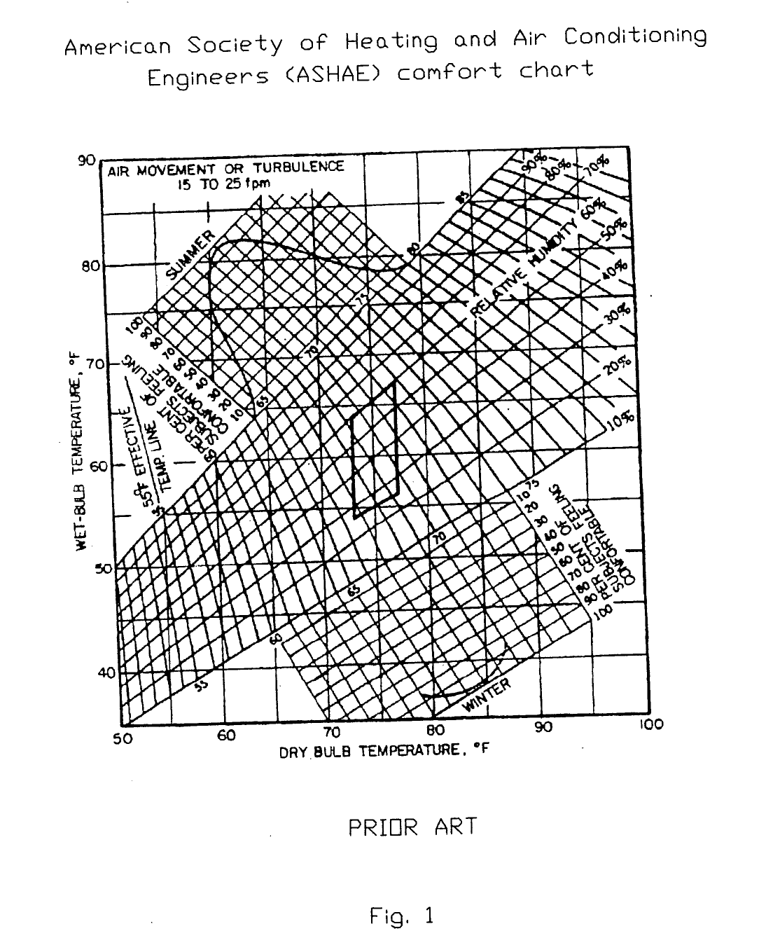

### FIGS. 1 THROUGH 10 PREFERRED EMBODIMENT

FIG. 1 ASHAE comfort chart shows the relationship of temperature and relative humidity, as it effects comfort summer and winter.

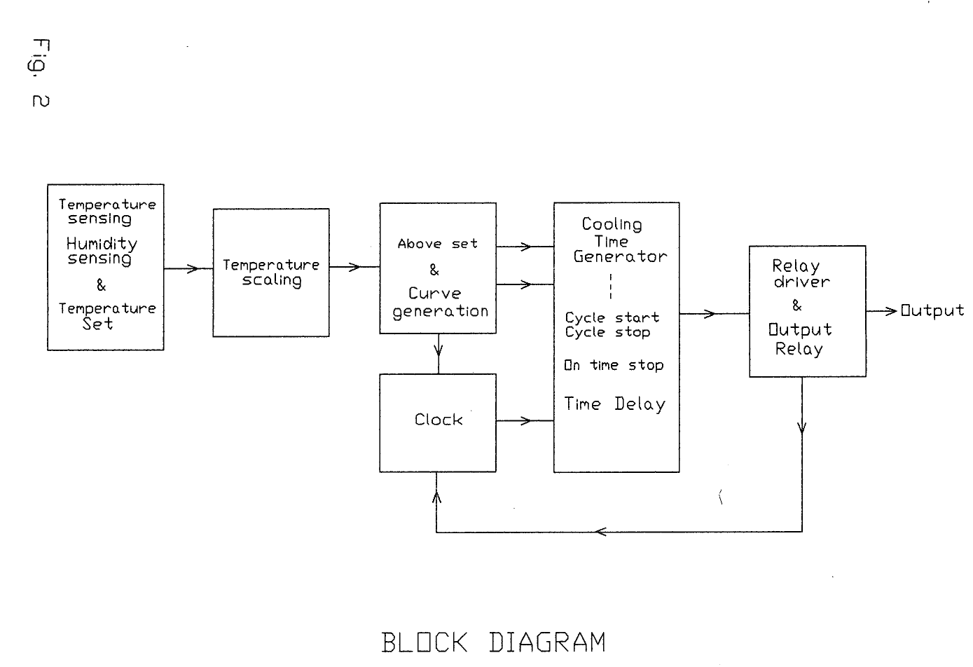

FIG. 2 shows a block diagram of my thermostat. The sensed temperature, humidity and temperature-set are combined to permit a user to select desired minimum effective temperature. The difference between indoor effective temperature and temperature-set is sent to temperature scaling, where the user selects an acceptable cooling response to temperature above temperature set. The scaled signal is sent to a curve generation block where the signal is split. One path is scaled linear or non-linear. And a second path determines if temperature is above or below temperature-set. These two signals are sent to the cooling time generator block and to the clock block. The clock block signal is also sent to the Cooling time generator block. In this block the signals are processed by the Cycle start, Cycle stop, On time stop and Time delay to generate an output signal to the Relay driver block. The Relay driver block controls the output relay. And feeds a signal back to the clock block.

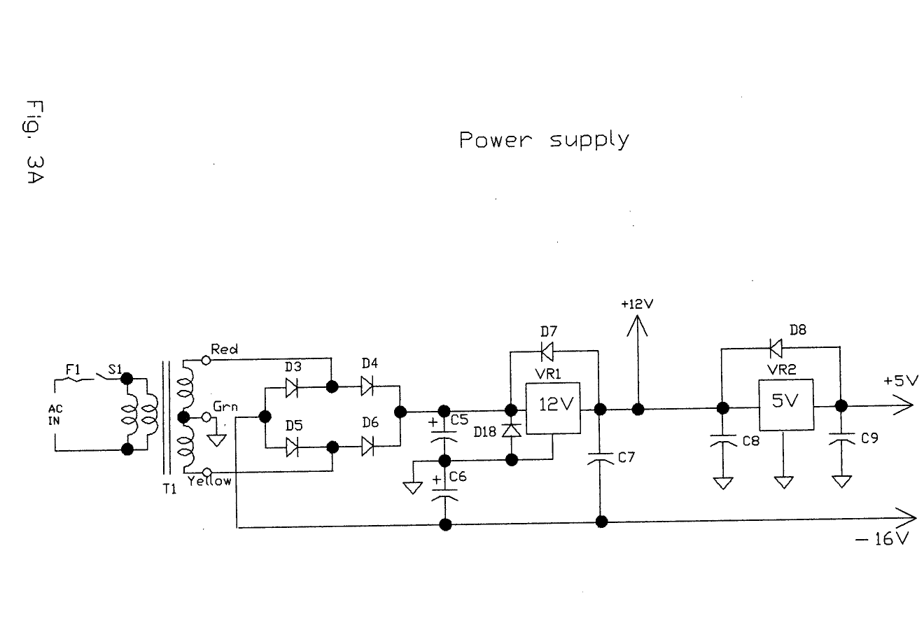

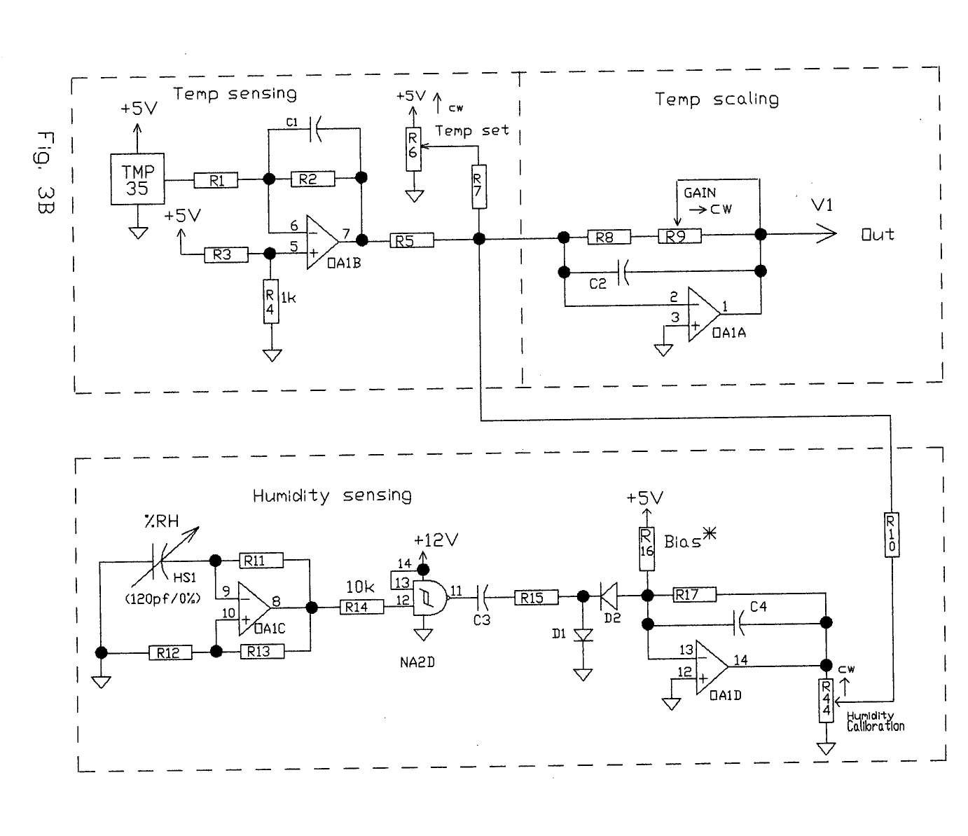

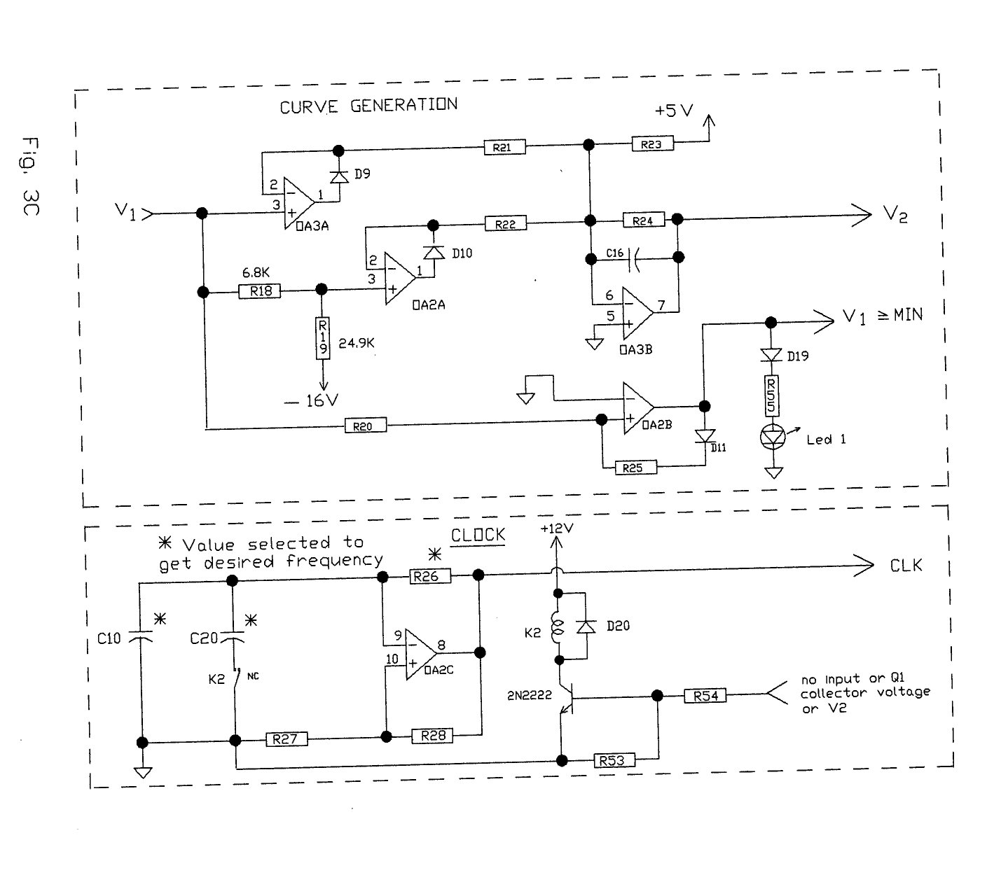

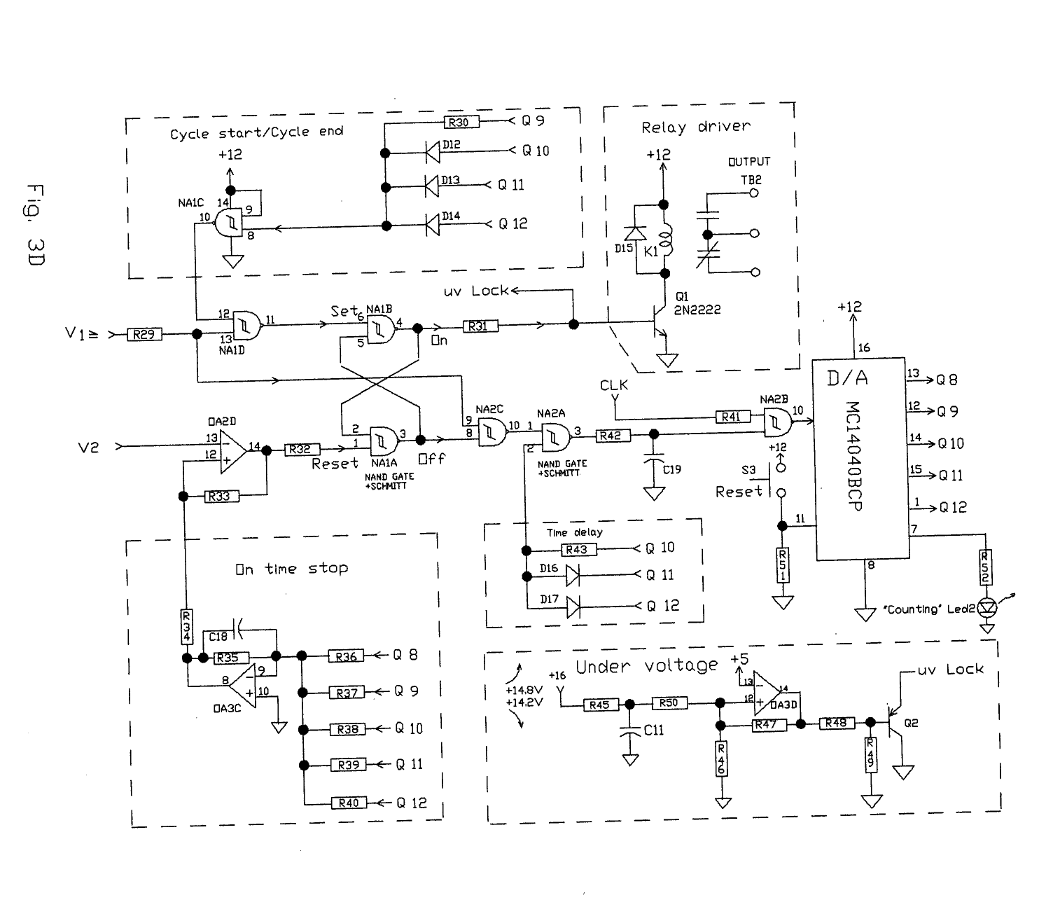

FIG. 3A shows the power supply used in my thermostat, −16 volt, +12 volt and +5 volt.

FIG. 3B includes temperature sensing, humidity sensing, temperature set and temperature scaling. TMP 35 senses temperature, its output amplified by OA1B. In the humidity circuit OA1C and surrounding components form an oscillator. HS1 changes capacitance as a linear function of relative humidity. Oscillator frequency is determined by HS1. The output is buffered by NA2D and connected to C3. Charging and discharging of C3 is rectified by D1 and D2 and integrated by the amplifier OA1D. In the input of OA1D is a bias circuit to calibrate the humidity sensing circuit, at a specific humidity. The output of the humidity circuit is scaled by R4 to achieve minus 0.7 degrees F. for a 10% relative humidity change. It is then combined with the output of the temperature circuit. This combination (effective temperature) is then modified by temperature-set, where the user selects minimum effective temperature of operation. Delta temperature above temperature set is the input to temperature scaling and can be an independent output for other uses. Temperature scaling determines the V1 voltage as a function of delta temperature above temperature-set. Cooling on time and off time is based a voltage signal that varies between zero volts and ten volts. Changing the scaling changes the number of degrees between minimum and maximum cooling time.

FIG. 3C shows V1 split into two paths, one sent to a curve generation circuit where V1 is scaled. The circuit shown is versatile and circuit values can be changed to provide either a linear or nonlinear V2 output. The second V1 signal path is through OA2B, an amplifier that functions as a switch. When V1 is below zero volts the output V2 is about −0.5 volts. But when V1, the input to OA2B is above zero, the output goes high. Led 1 indicates when inside temperature is above temperature-set. FIG. 3C also includes a clock oscillator with output labeled CLK. The clock oscillator frequency can be changed as a function of temperature or as a function of the thermostat's output condition. V1≧0, V2 and CLK are inputs to logic circuit FIG. 3D.

FIG. 3D in the under voltage circuit Q 2 performs a lock out function to prevent operation of the output relay if power supply voltage is too low for proper logic operation. Clock input CLK is converted from digital to analog by a D/A converter. Led 2 flashes to indicate counting. The relay driver circuit is energized when all required conditions are met, a relay is energized and a circuit to activate cooling is established. If input V1 is high, counting is started and a request for cooling is initiated. If V1 goes low, timing is stopped and if the minimum cooling on time was not supplied a time delay circuit provides additional time, to insure a minimum cooling on time. This time delay function is provided by the inputs Q10, Q11 and Q12 to the NA2A NAND gate. The on time stop circuit stops cooling when the output of OA3C exceeds V2 as a result of inputs Q8, Q9, Q10, Q11, and Q12. Starting at the initiation of cooling, the output voltage of OA3C increases about 0.357 volts each time initiated step. When voltage output of OA3C exceeds V2 voltage the request for cooling is stopped. After the cycle is completed the cycle will start again if V1 is high. But if input V2 to OA2D exceeds 10 volts when the output of OA3C reaches 10 volts timing is stopped and the request for cooling remains on until the V2 voltage drops below 10 volts. Timing is then restarted and a time delay is provided, to allow for compressor pressure bleed off. Inputs Q1O, Q11, and Q12 to NA2A provide this time delay. In the cycle end, restart circuit inputs Q9, Q10, Q1 and Q12 to NA1C determine cycle end time. If at the end of a cycle cooling cycle V1 remains high or becomes high a new cooling time cycle is initiated.

Operation—Preferred Embodiment

This description is basic operation with a predetermined time cycle (Oscillator frequency fixed). Temperature-set uses a combination of relative humidity and dry bulb temperature, i.e. effective temperature. In FIG. 3B the input voltage on pin 2 of OA1A represents a temperature difference between the enclosed space temperature and temperature-set. The output voltage of OA1A represents the scaled delta temperature above-temperature-set. When voltage representing ten degrees input above temperature-set results in ten volts output (V1) the scale factor is one. When a voltage representing five degrees above temperature-set results in ten volts output (V1) the scale factor is two. When a voltage representing two degrees above temperature-set results in ten volts output (V1) the scale factor is five. Scale factors can be below one and above five but the effects of this wider range are not presented herein.

In FIG. 3C the (V1) voltage, whether scaled linear or non-linear, the output labeled (V2) retains the (V1) input scaling at zero and at the ten-volt level.

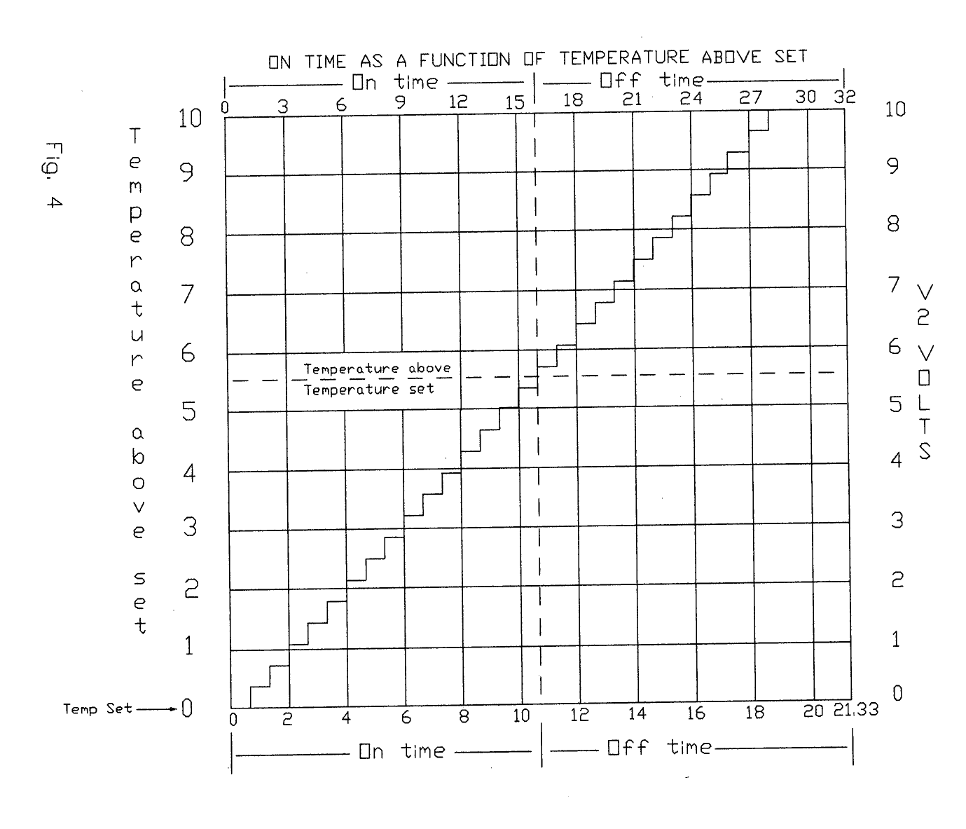

A D/A converter is a device that changes a digital input to an analogue output. Each time a specific count is reached output voltage is raised. FIG. 4 shows output of the D/A converter. With time per step about one second and a voltage increase per step about 0.357 volts. It also shows fixed delta temperature above temperature-set, scale factor one with linear scaling. If the inside temperature is above temperature-set cooling starts at the beginning of a time cycle and ends when the D/A output voltage exceeds V2 voltage. For the temperature shown in FIG. 4 on time is approximately 16 minutes and off time is approximately 16 minutes. If the temperature above temperature-set changes the on time and off time will also change. This makes cooling on and off time a function of delta temperature above temperature-set.

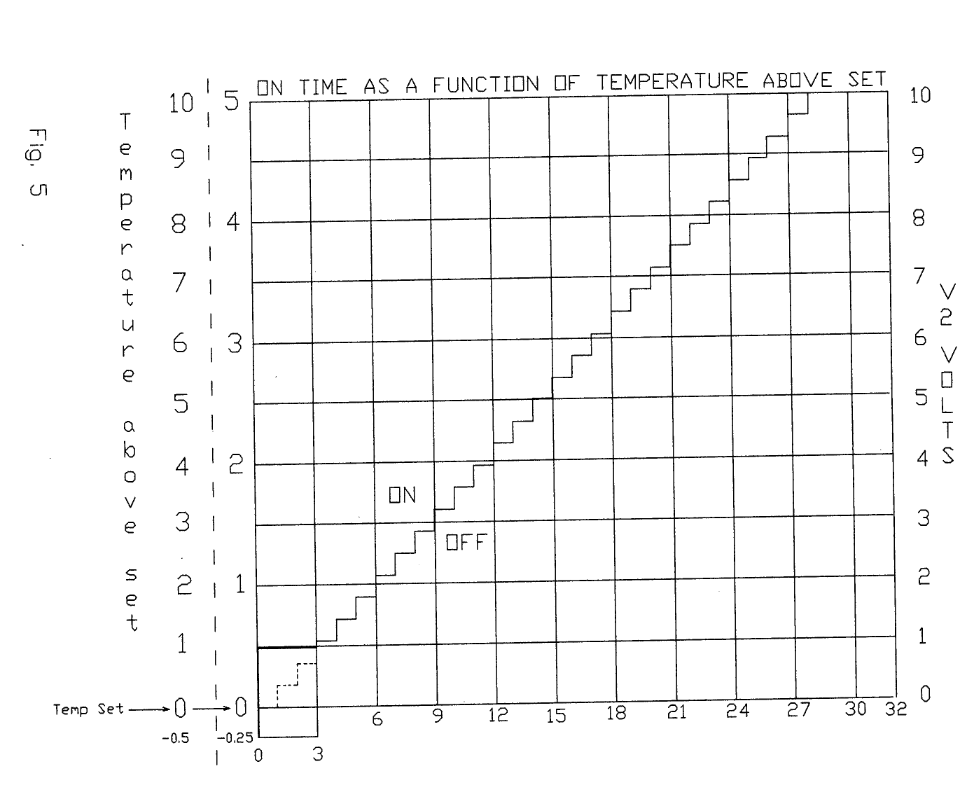

FIG. 5 shows the temperature above set scale factor one and scale factor two, with linear V1 to V2 scaling. The timing logic circuits operate between zero and ten volts this permits multiple scaling of temperature to be shown on the same figure. Output V2 is biased to start at one volt for any temperature above set, which results in a minimum cooling time of three minutes. This bias can be changed to get a different minimum cooling time. As temperature above temperature-set increases, the cooling time increases. If the temperature decreases to below temperature-set, including hysterics after cooling has started, the time delay keeps the count going to permit the cooling request to be completed. On time increases with increases in temperature above temperature-set until the scaled temperature (voltage) exceeds ten volts. Ten volts is the output of the D/A converter at 28 minutes. If the voltage generated by the delta temperature above temperature-set exceeds the D/A output at 28 minutes, timing is stopped and cooling remains on until the voltage drops to below ten volts. When the voltage drops below 10 volts cooling is stopped and counting restarted and a time delay is provided for pressure bleed off, before the next cooling cycle can start.

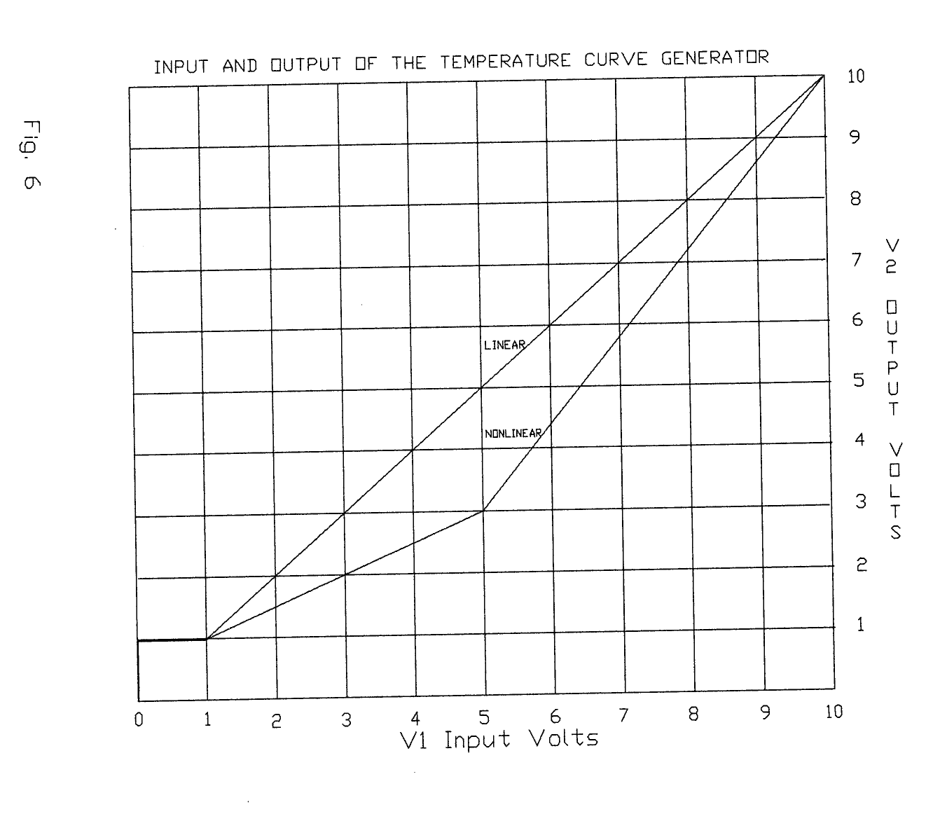

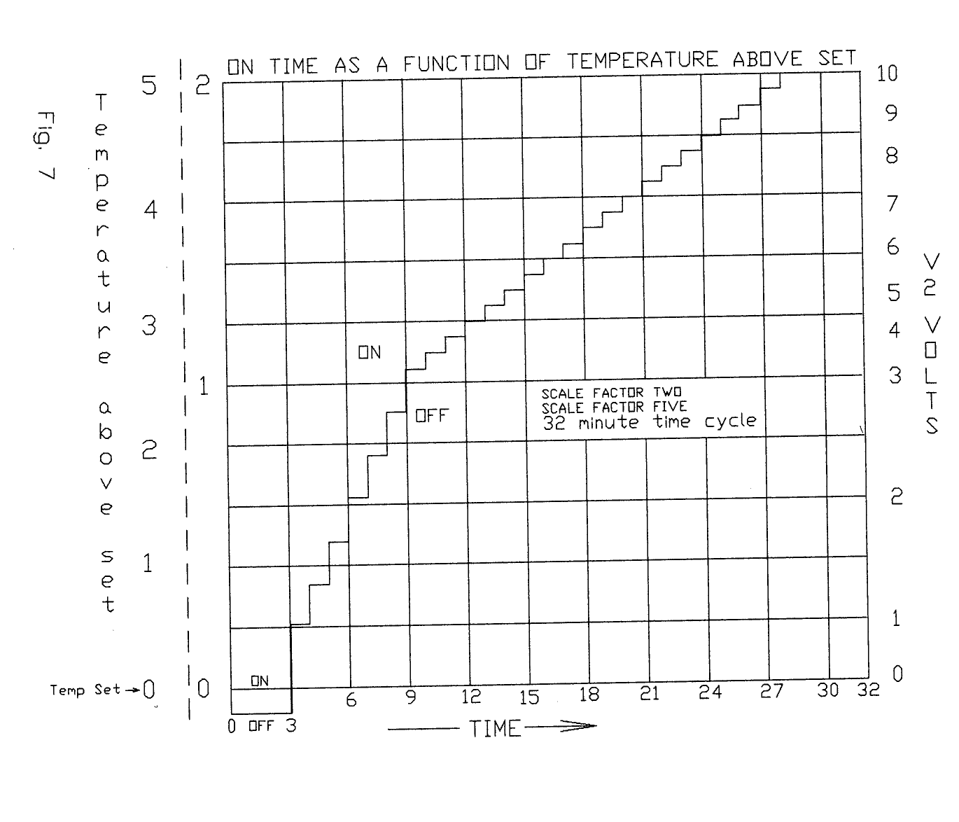

FIG. 6 shows both linear and non linear V2 as a function of V1 and FIG. 7 shows the cooling obtained with the non-linear scaling shown in FIG. 6 using scale factor two and five.

The above operating description was for a specific predetermined time cycle. FIG. 3C shows three clock conditions. Fixed frequency, frequency modified by input from scaled delta temperature and frequency changed every time the output condition changes. Scaled V2 temperature voltage can be used to increase the frequency of the clock to shorten the off time at low heat-load conditions. This will help eliminate stuffiness between cooling cycles. The collector voltage on Q1 can be used to decrease the off time (increase the frequency) each time the Q1 collector goes high. Then the remainder of the cycle will be at a higher frequency to minimize off time.

### ADDITIONAL EMBODIEMENTS

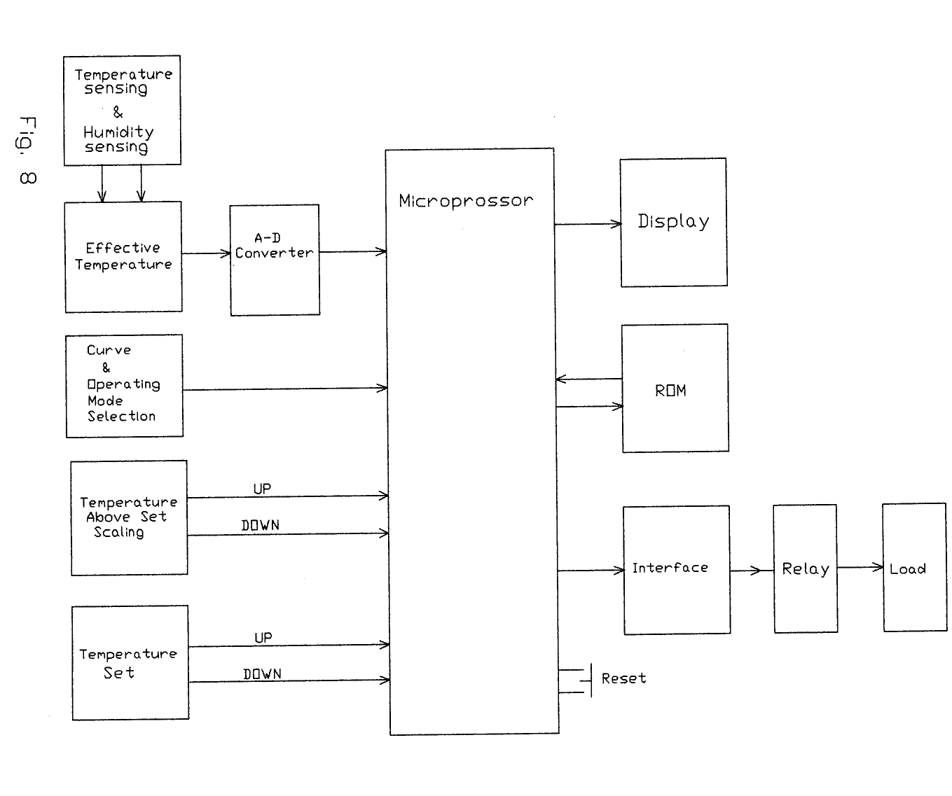

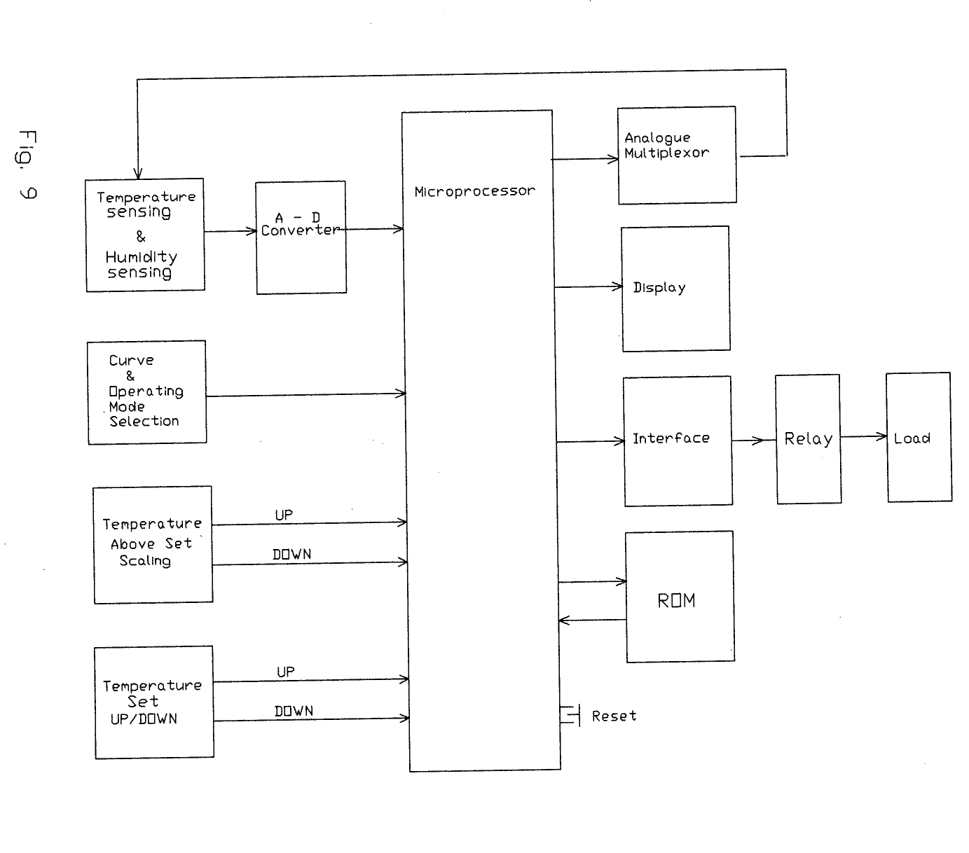

Additional embodiment—FIG. 8 and FIG. 9 are microprocessor configurations where the operating program and multiple operating parameters are stored in a ROM.

Operation—FIG. 8 and FIG. 9

In FIG. 8 temperature and humidity are combined for sending to the microprocessor through a single A/D converter and in FIG. 9 these two signals are multiplexed for sending to the microprocessor through a single A/D converter. The operating program and multiple performance profiles including variable time cycle programs and several predetermined time cycles can be stored in a read only memory. The installer or user selects the basic operating parameters, the desired time cycle parameters and selects a performance profile. The user then selects temperature-set using up/down inputs and selects a cooling response to temperature above temperature-set also using up/down inputs. A display shows setup information, provide useful information such as temperature-set, delta temperature above temperature-set, relative humidity and the cooing response to temperature above temperature-set. A reset provides the user a method to reset the clock and start the cycle over. A microprocessor output requires an interface to provide sufficient energy to change the state of the output relay from off to on or on to off. This output relay connects the thermostat to the load.

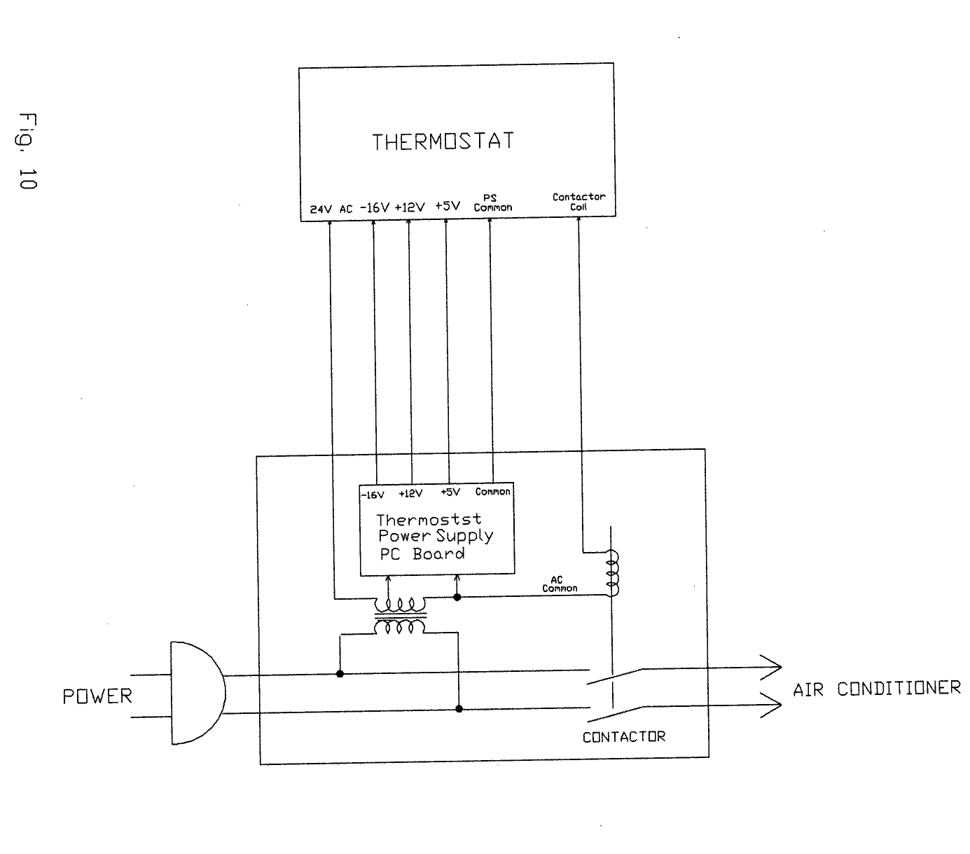

Additional embodiment—FIG. 10 shows add on control for room air conditioners.

Operation—FIG. 10

In FIG. 10 a device capable of controlling the line current to a window or room air conditioner is controlled by the output of my thermostat. The switching device and the thermostat power supply portion are connected to power and are housed in a separate enclosure. The control portion of the thermostat is connected to this separate enclosure, with low voltage wire of sufficient length for convenient mounting of the thermostat. The air conditioner to be controlled is also connected to this separate enclosure. The air-conditioner switch is left in the on position and its internal thermostat set to a low temperature. The power to operate the external thermostat is supplied from the same power source that supplies power to the air-conditioner except when a battery operated microprocessor thermostat is used to control the switching device. With this configuration the user can have the comfort and operating cost savings provided by my thermostat while using an already existing window or room air conditioner. Using this external control will eliminate undershoot, save operating costs, and will provide more comfort for all heat load conditions.

Conclusion, Ramification, and Scope

Accordingly, the reader will conclude using temperature modified by relative humidity improves comfort. And permitting inside temperature to vary with heat-load provides additional comfort and saves power. Using enclosed space delta temperature above temperature-set to control cooling on time and off time has many advantages. My thermostat controls the off time to reduce or eliminate a space becoming stuffy between cooling cycles. It eliminates undershoot which permits the temperature-set to be lower than conventional thermostats without making people feeling cold. It controls the temperature down to temperature-set in the evening and at night as the outside temperature decreases. Timed cooling provides comfort while it gradually reduces latent heat in the structure. The following day a flywheel effect of the structure's thermal mass retards the temperature increase and reduces energy consumption. As a result some of the energy used the night before is recovered. As outside temperature increases inside temperature is permitted to increase to compensate for increased heat-load and it will also reduce electrical costs. Periodic cooling, a function of the inside temperature above temperature-set, provides comfort while the inside temperature increases. Temperature will increase until the cooling provided equals heat load. A user determines the temperature that is comfortable at night, for cool days, and the amount of cooling provided as the temperature inside increases. If comfort is important the user will select a temperature scaling to limit the temperature increase to a level that provides the desired comfort on hot days. But if cost savings are more important than comfort the user can determine how much comfort they are willing to sacrifice to save additional operating costs.

After selecting temperature-set and the cooling response to temperature, my thermostat will keep the inside environment within the user selected parameters without requiring further user attention.

Time controlled cooling can achieve a lower humidity with normal efficiency by controlling operation of an air conditioner to lower temperatures without people feeling cold. My thermostat can provide more air conditioning comfort at a lower operating cost than traditional air conditioner thermostats operated under similar heat-load conditions.

A microprocessor can provide flexibility, including battery operation, a programmed ROM with several cooling profiles as a function of delta temperature above temperature-set, temperature controlled and cooling time controlled time cycle programs, several fixed time cycles and a means to select the desired operating parameters.

The microprocessor version of my thermostat can be more flexible and be very user friendly; therefore it will be used in most applications.

Summary of Advantages:

It provides more comfort than traditional fixed temperature thermostats.
It permits temperature to be modified by relative humidity for enhanced comfort.
It allows the user to adjust the delta temperature response to heat-load changes.
It provides improved humidity control under a wide range of temperature conditions.
It provides short cooling on time with controlled off time to eliminate temperature undershoot and to decrease or eliminate stuffiness under low heat-load conditions.
It permits a slow decrease in temperature with periodic timed cooling to provide comfort as it slowly reduces the latent heat in a structure.
It permits a lower temperature-set without causing people to feel cold.
It permits inside temperature to increase with increasing heat-load to provide a comfortable healthy temperature and reduce operating costs.
It allows the user to depend on the thermostat to maintain comfort and save power.
It permits the user to exchange comfort for additional power savings.
It can be digitized for microprocessor application.
It will provide more comfort when used to control existing window air conditioners.

Although the descriptions above contains specificity's, these should not be construed as limiting the scope of the invention but merely providing illustrations of some of the presently preferred embodiments of this invention. For example: Cooling time as a function of the inside delta temperature above temperature-set can be scaled either linear or non-linear. The predetermined cycle time can be fixed or made a function of the on time or a function of the delta temperature. The number of steps in the D/A process changed. It can be programmed for microprocessor applications. It can be incorporated in heating and cooling thermostats. It can be used to externally control window or room air conditioners. This air conditioning thermostat can be used as the cooling portion in heating and cooling thermostats and may find use in humidity control equipment.

Thus the scope of the invention should be determined by the appended claims and their legal equivalents, rather than by the examples given.

I claim:

1. A method of controlling an air conditioner unit comprising:
(a) measuring the enclosed space temperature;
(b) selecting a user desired temperature-set; and
(c) controlling the unit cooling on time and the unit off time dependent upon the temperature difference between the enclosed space temperature and the desired temperature-set.

2. The method of controlling an air conditioner unit of claim (1) wherein said controlling of said unit cooling on time and said unit off time is within a predetermined time cycle.

3. The method of controlling an air conditioner unit of claim (2) wherein said controlling within in the predetermined cycle time is based upon a relationship between characteristics of said enclosed space and characteristics of said air conditioner.

4. The method of controlling an air conditioner unite of claim (1) where is said controlling said unit cooling on time and said unit off time is within a time cycle dependent upon said temperature difference between said enclosed space temperature and said desired temperature-set.

5. The method of controlling an air conditioner unite of claim (1) where is said controlling said unit cooling on time and said unit off time is within a time cycle dependent upon said unit cooling on time or said unit off time.

6. The method of controlling an air conditioner unit of claim (1) further comprising: said controlling includes varying the gain of said temperature difference in control of said unit cooling on-time, in response to a user gain input.

7. The method of controlling an air conditioner unit of claim (1) further comprising: sensing relative humidity in said enclosed space; and said controlling of said unit on time is further dependent upon relative humidity sensed in said enclosed space.

8. The method of controlling an air conditioner unit of claim (7) further comprises varying said sensed temperature by a factor of minus 0.7 degrees F. per 10% relative humidity sensed.

9. The method of controlling an air conditioner unit of claim (7) wherein said humidity sensing includes using a humidity sensor having a capacitance output; said output of said sensor controls the frequency of a signal; wherein said signal is used to indicate sensed relative humidity.

10. The method of controlling an air conditioner unit of claim (1) wherein the relationship between said on time and said temperature difference is generally linear.

11. The method of controlling an air conditioner unit of claim (10) wherein slope of said linear relationship is variable.

12. The method of controlling an air conditioner unit of claim (10) wherein said relationship is composed of small incremental steps, which are generally linear.

13. The method of controlling an air conditioner unit of claim (1) wherein the relationship between said on time and said temperature difference is nonlinear.

14. The method of controlling an air conditioner unit of claim (13) where said relationship produces a generally higher rate of decreasing said on time as said temperature difference decreases resulting from a lower sensed temperature.

15. The method of controlling an air conditioner unit of claim (1) wherein said controlling utilizes a microprocessor.

16. The method of controlling an air conditioner unit of claim (15) further comprises storing a plurality of curves and operating modes representing various desired operation of said air conditioning unit; and said controlling includes selecting an appropriate one of said curves and selecting one of said operating modes.

17. The method of controlling an air conditioner unite of claim (15) further including said selecting one of said curves and one of said operating modes is based upon a user input.

18. The method of controlling an air conditioner unit of claim (1) further comprising: using said controlling to energize an AC line contactor which controls the on time of a room air conditioning unit.

19. An air conditioning thermostat for control of cooling on time and cooling off time, within a time cycle, dependent upon temperature difference between enclosed space temperature and temperature-set, comprising:
(a) a means to measure said enclosed space temperature;
(b) a means to select said temperature-set;
(c) a means to provide said time cycle; and
(d) a means to control said cooling on time and said cooling off time, within said time cycle, dependent upon said temperature difference between said enclosed space temperature and said temperature-set.

20. An air conditioning thermostat of claim (19) further comprising:
(a) a means to sense relative humidity within said enclosed space; and
(b) a means to modify said cooling on time and said cooling off time dependent upon said relative humidity in said enclosed space.

21. an air conditioning thermostat of claim (19) further comprising:
(a) a means to modify said time cycle dependent upon said temperature difference between said enclosed space temperature and said temperature-set.

22. an air conditioning thermostat of claim (19) further comprising:
(a) a means to modify said time cycle dependent upon said cooling on time and or said cooling off time.
